(19) United States
(12) Patent Application Publication
(10) Pub. No.: US 2022/0129437 A1
(43) Pub. Date: Apr. 28, 2022

(54) CONFIGURATION METADATA RECOVERY

(71) Applicant: EMC IP Holding Company LLC, Hopkinton, MA (US)

(72) Inventors: Charles Ma, Beijing (CN); Shaoqin Gong, Beijing (CN); Geng Han, Beijing (CN); Vamsi K. Vankamamidi, Hopkinton, MA (US); Shuyu Lee, Acton, MA (US); Ping Ge, Beijing (CN); Jian Gao, Beijing (CN)

(21) Appl. No.: 17/081,434

(22) Filed: Oct. 27, 2020

(51) Int. Cl. G06F 16/23; G06F 3/06

(52) U.S. Cl. CPC G06F 16/2365; G06F 3/0655; G06F 3/0614; G06F 3/0689

(57) ABSTRACT

Technology for configuration metadata recovery that detects a reliability failure regarding configuration metadata stored in non-volatile data storage of a data storage system. The configuration metadata indicates how a metadata database is stored in the non-volatile data storage of the data storage system. In response to detection of the reliability failure regarding the configuration metadata, the technology identifies valid generations of the configuration metadata that are currently stored in the non-volatile data storage of the data storage system, and determines a user-selected one of the valid generations of the configuration metadata. The metadata database is accessed based on the user-selected one of the valid generations of the configuration metadata.

### TECHNICAL FIELD

The present disclosure relates generally to data storage systems that provide reliable storage for configuration metadata that describes a metadata database that is used by the data storage system, and more specifically to technology for recovering the stored configuration metadata in response to detection of a reduced level of reliability with regard to the configuration metadata.

### BACKGROUND

Data storage systems are arrangements of hardware and software that include one or more storage processors coupled to non-volatile data storage drives, such as solid state drives and/or magnetic disk drives. Each storage processor may service host I/O requests received from physical and/or virtual host machines (“hosts”). The host I/O requests received by the storage processor may specify one or more storage objects (e.g. logical units (“LUNs”), and/or files, etc.) that are hosted by the storage system and identify user data that is written and/or read by the hosts. Each storage processor executes software that processes host I/O requests and performs various data processing tasks to organize and persistently store the user data in the non-volatile data storage drives of the data storage system.

Some data storage systems use a metadata database to store metadata that is used by the data storage system when storing user data into the non-volatile data storage drives of the data storage system. Such a metadata database may include or consist of a metadata database that describes how mapped RAID (Redundant Array of Independent Disks) data protection is applied by the data storage system when persistently storing user data and/or related metadata. Configuration metadata may be used by the data storage system to locate and access the metadata database within the non-volatile data storage drives of the data storage system, e.g. at the time the data storage system boots up.

### SUMMARY

The configuration metadata of a data storage system should be stored in a manner that ensures a high level of reliability. For example, multiple identical copies of one or more generations of the configuration metadata may be stored in regions of the individual non-volatile data storage drives of the data storage system. In the event that the data storage system detects that more than a predetermined proportion of the persistently stored copies of the configuration metadata are not accessible, a failure event may be triggered indicating that the data storage system has insufficient confidence in the configuration metadata to continue operation, e.g. to continue booting up during a restart. This type of reliability failure may occur when some number of the non-volatile data storage drives become inaccessible, e.g. because multiple drives have become disconnected from the storage processor(s) of the data storage system. In such circumstances, some previous data storage systems have simply discontinued the boot process at the point where the configuration metadata reliability failure was detected. By discontinuing the boot process at that point, the data storage system may not become sufficiently operable to indicate the cause of the reliability failure, i.e. the inaccessibility of certain non-volatile data storage drives that have become disconnected. As a result, a user of the data storage system cannot efficiently identify and correct the failure, e.g. by re-connecting the disconnected non-volatile data storage drives.

To address the above described and other shortcomings of previous technologies, new technology for configuration metadata recovery is disclosed herein that detects a reliability failure regarding configuration metadata stored in the non-volatile data storage of a data storage system. The stored configuration metadata indicates how a metadata database is stored in the non-volatile data storage of the data storage system. In response to detection of the reliability failure regarding the configuration metadata, the disclosed technology identifies valid generations of the configuration metadata that are currently stored in the non-volatile data storage of the data storage system, and determines a user-selected one of the valid generations of the configuration metadata. The metadata database is accessed in the non-volatile data storage of the data storage system based on the user-selected one of the valid generations of the configuration metadata.

In some embodiments, the valid generations of the configuration metadata may be identified at least in part by, for each generation of the configuration metadata currently stored in at least one currently accessible data storage drive in the non-volatile data storage of the data storage system, loading the metadata database using the generation of the configuration metadata, and determining that the generation of the configuration metadata is valid in response to successfully loading the metadata database using that generation of the configuration metadata and determining that the loaded metadata database is valid.

In some embodiments, accesses to the metadata database that are based on the user-selected one of the valid generations of the metadata database may include locating at least one portion of non-volatile data storage of the data storage system that stores the metadata database using an indication of the at least one portion of non-volatile data storage (e.g. address, offset, etc.) stored in the contents of the user-selected one of the valid generations of the configuration data.

In some embodiments, the at least one portion of non-volatile data storage of the data storage system that stores the metadata database may be multiple drive extents that are used by the data storage system to provide mapped RAID (Redundant Array of Independent Disks) data protection for the metadata database.

In some embodiments, the RAID data protection provided by the data storage system for the metadata database may be mirroring of the metadata database onto each one of the multiple drive extents, such that each one of the drive extents stores a separate copy of the metadata database.

In some embodiments, the metadata database may be a RAID metadata database that includes one or more tables or the like describing how user data and/or other metadata is stored by the data storage system in the non-volatile data storage of the data storage system in order to provide mapped RAID data protection for the user data and/or metadata.

In some embodiments, the disclosed technology detects the reliability failure regarding the configuration metadata by detecting that the configuration metadata can currently be read from less than a predetermined proportion of the non-volatile data storage drives in the non-volatile data storage of the data storage system.

In some embodiments, the predetermined proportion of the non-volatile data storage drives in the non-volatile data storage of the data storage system is a majority of the non-volatile data storage drives in the non-volatile data storage of the data storage system.

In some embodiments, the disclosed technology detects the reliability failure regarding the configuration metadata by detecting the reliability failure for the configuration metadata while booting the data storage system.

Embodiments of the disclosed technology may provide significant advantages over previous technical solutions. For example, the disclosed technology enables a data storage system to handle a failure event triggered by insufficient confidence in stored configuration metadata and then continue operation, e.g. in order to continue booting up during a restart using the user-selected valid generation of the configuration metadata. In this way, the disclosed technology may be embodied to allow the data storage system to boot up when multiple non-volatile data storage drives have become inaccessible as a result of a lost connection to the storage processor(s) of the data storage system. Advantageously, the data storage system may become sufficiently operable to indicate the actual cause of the reliability failure, i.e. the inaccessibility of specific non-volatile data storage drives that have become disconnected. As a result, the user of the data storage system can efficiently identify and correct the failure, e.g. by re-connecting the disconnected non-volatile data storage drives.

### BRIEF DESCRIPTION OF THE DRAWINGS

The objects, features and advantages of the disclosed technology will be apparent from the following description of embodiments, as illustrated in the accompanying drawings in which like reference numbers refer to the same parts throughout the different views. The drawings are not necessarily to scale, emphasis instead being placed on illustrating the principles of the disclosed technology.

FIG. 1 is a block diagram showing an example of a data storage system in which an example of the disclosed technology is embodied;

FIG. 2 is a block diagram showing an example of drive extents, a RAID extent, and a tier, provided using mapped RAID technology in some embodiments;

FIG. 3 is a block diagram showing an example structure of a metadata database in some embodiments;

FIG. 4 is a flow chart showing an example of steps performed during operation in some embodiments;

FIG. 5 is a block diagram showing an example of the storage and contents of configuration metadata in some embodiments;

FIG. 6 is a block diagram showing an example of the storage and contents of configuration metadata generations generated in response to a drive failure in some embodiments;

FIG. 7 is a block diagram showing a second example of the storage and contents of configuration metadata generations in some embodiments; and

FIG. 8 is a block diagram showing the example of the configuration metadata generations of FIG. 7 after a configuration metadata reliability failure.

### DETAILED DESCRIPTION

Embodiments of the invention will now be described with reference to the figures. The embodiments described herein are provided only as examples, in order to illustrate various features and principles of the disclosed technology, and the invention is broader than the specific embodiments described herein.

Embodiments of the disclosed technology provide improvements over previous technologies by enabling a data storage system to handle a failure event triggered by insufficient confidence in stored configuration metadata and continue operation based on a user-selected, validated generation of the configuration metadata. The disclosed technology can enable a data storage system to boot up when multiple copies of the configuration metadata have become inaccessible, and become sufficiently operable to indicate a failure cause, e.g. the inaccessibility of specific non-volatile data storage drives that have become disconnected from the storage processor(s).

During operation of some embodiments, a reliability failure is detected regarding configuration metadata stored in the non-volatile data storage of the data storage system. The configuration metadata indicates how a metadata database is stored in the data storage system. In response to detecting the reliability failure regarding the configuration metadata, valid generations of the configuration metadata are identified, and presented to a user (e.g. displayed to the user for selection by the user). A user-selected one of the valid generations of the configuration metadata is detected, and the metadata database is subsequently accessed based on the user-selected one of the valid generations of the configuration metadata, e.g. in order to continue booting the data storage system.

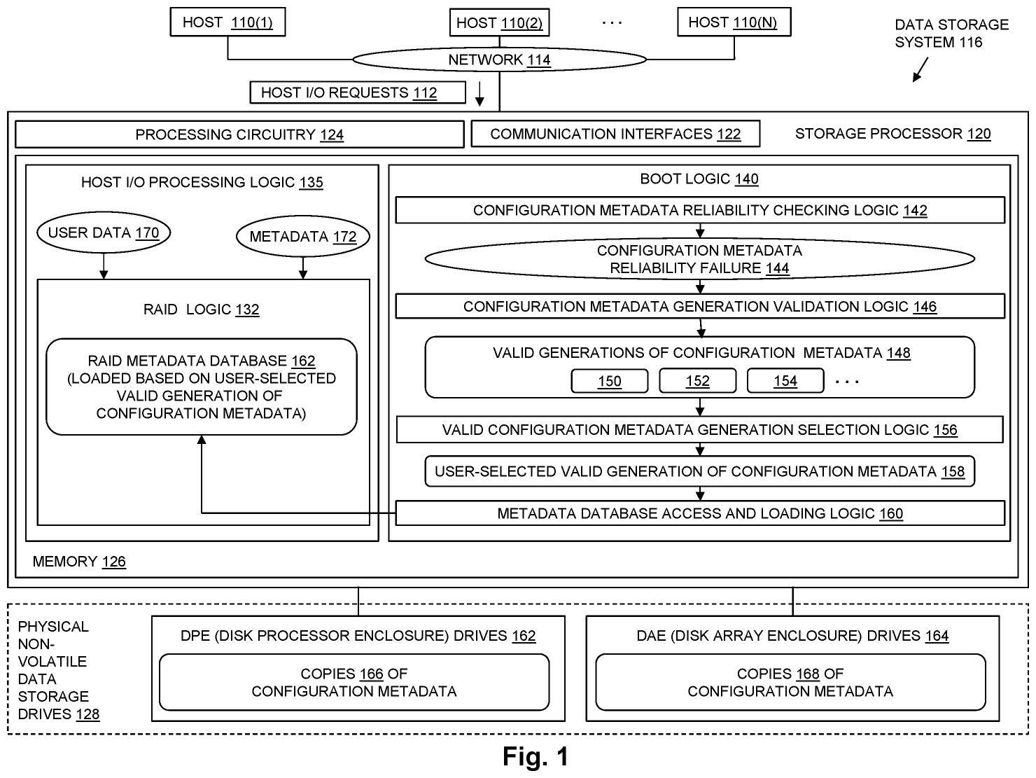

FIG. 1 is a block diagram showing an operational environment for the disclosed technology, including an example of a data storage system in which the disclosed technology is embodied. FIG. 1 shows a number of physical and/or virtual Host Computing Devices 110, referred to as “hosts”, and shown for purposes of illustration by Hosts 110(1) through 110(N). The hosts and/or applications may access data storage provided by Data Storage System 116, for example over one or more networks, such as a local area network (LAN), and/or a wide area network (WAN) such as the Internet, etc., and shown for purposes of illustration in FIG. 1 by Network 114. Alternatively, or in addition, one or more of Hosts 110(1) and/or applications accessing data storage provided by Data Storage System 116 may execute within Data Storage System 116. Data Storage System 116 includes at least one Storage Processor 120 that is communicably coupled to both Network 114 and Physical Non-Volatile Data Storage Drives 128, e.g. at least in part though one or more Communication Interfaces 122. No particular hardware configuration is required, and Storage Processor 120 may be embodied as any specific type of device that is capable of processing host input/output (I/O) requests (e.g. I/O read and I/O write requests, etc.) and persistently storing user data.

The Physical Non-Volatile Data Storage Drives 128 may include physical data storage drives such as solid state drives, magnetic disk drives, hybrid drives, optical drives, and/or other specific types of drives. In the example of FIG. 1, Physical Non-Volatile Data Storage Drives 128 include DPE (Disk Processor Enclosure) Drives 162, and DAE (Disk Array Enclosure) Drives 164. DPE Drives 162 are contained in a DPE that also contains the Storage Processor 120, and may be directly connected to Storage Processor 120. The DAE Drives 164 are contained in one or more DAEs that are separate from and external to the DPE, and are therefore indirectly connected to the Storage Processor 120, e.g. through one or more communication links connecting the DAEs to the Storage Processor 120, the DPE, and/or to other DAEs. Failure of a single communication link that connects the DAE Drives 164 to the Storage Processor 120 may result in all of drives in DAE Drives 164 becoming inaccessible to Storage Processor 120, and may, for example, cause the disclosed technology to detect a reliability failure with regard to the configuration metadata, as further described herein.

A Memory 126 in Storage Processor 120 stores program code that is executable on Processing Circuitry 124, as well as data generated and/or processed by such program code. Memory 126 may include volatile memory (e.g. RAM), and/or other types of memory. The Processing Circuitry 124 may, for example, include or consist of one or more microprocessors, e.g. central processing units (CPUs), multi-core processors, chips, and/or assemblies, and associated circuitry.

Processing Circuitry 124 and Memory 126 together form control circuitry that is configured and arranged to carry out various methods and functions described herein. The Memory 126 stores a variety of software components that may be provided in the form of executable program code. For example, Memory 126 may include software components such as Host I/O Processing Logic 135 and/or Boot Logic 140. When program code stored in Memory 126 is executed by Processing Circuitry 124, Processing Circuitry 124 is caused to carry out the operations of the software components. Although certain software components are shown in the Figures and described herein for purposes of illustration and explanation, those skilled in the art will recognize that Memory 126 may include various other types of software components, such as operating system components, various applications, hosts, other specific processes, etc.

During operation, Host I/O Processing Logic 135 persistently stores User Data 170 indicated by write I/O requests in Host I/O Requests 112 into the Physical Non-Volatile Data Storage Drives 128. RAID Logic 132 provides mapped RAID data protection for the User Data 170 indicated by write I/O requests in Host I/O Requests 112, and/or for related Metadata 172. In this regard, in order to provide mapped RAID data protection, RAID Logic 132 divides each of the non-volatile data storage drives in Physical Non-Volatile Data Storage Drives 128 into multiple, equal size drive extents. Each drive extent consists of physically contiguous non-volatile data storage located on a single data storage drive. For example, in some configurations, RAID Logic 132 may divide each one of the physical non-volatile data storage drives in Physical Non-Volatile Data Storage Drives 128 into the same fixed number of equal size drive extents of physically contiguous non-volatile storage. The size of the individual drive extents into which the physical non-volatile data storage drives in Physical Non-Volatile Data Storage Drives 128 are divided may, for example, be the same for every physical non-volatile data storage drive in Physical Non-Volatile Data Storage Drives 128. Various specific sizes of drive extents may be used in different embodiments. For example, in some embodiments, each drive extent may have a size of 10 gigabytes. Larger or smaller drive extent sizes may be used in the alternative for specific embodiments and/or configurations.

RAID Logic 132 organizes some or all of the drive extents in Physical Non-Volatile Data Storage Drives 128 into discrete sets of drive extents that are used to support corresponding RAID extents. Each set of drive extents is used to store data, e.g. User Data 170 or Metadata 172, that is written to a single corresponding logical RAID extent. For example, each set of drive extents is used to store data written to logical block addresses within a range of logical block addresses (LBAs) mapped to a corresponding logical RAID extent. Assignments and mappings of drive extents to their corresponding RAID extents are stored in RAID Metadata Database 162, e.g. in one or more RAID mapping tables. In this way RAID Metadata Database 162 describes how User Data 170 and/or Metadata 170 is stored by Data Storage System 116 in the Physical Non-Volatile Data Storage Drives 128 in order to provide mapped RAID data protection for User Data 170 and/or Metadata 172.

RAID Logic 132 stores data written to the range of logical block addresses mapped to a specific RAID extent using a level of RAID protection that is provided for that RAID extent. Parity based RAID protection or mirroring may be provided for individual RAID extents. For example, parity based RAID protection may use data striping (“striping”) to distribute data written to the range of logical block addresses mapped to a given RAID extent together with corresponding parity information across the drive extents assigned and mapped to that RAID extent. For example, RAID Logic 132 may perform data striping by storing logically sequential blocks of data and associated parity information on different drive extents that are assigned and mapped to a RAID extent as indicated by the contents of RAID Metadata Database 162. One or more parity blocks may be maintained in each stripe. For example, a parity block may be maintained for each stripe that is the result of performing a bitwise exclusive “OR” (XOR) operation across the logically sequential blocks of data contained in the stripe. When the data storage for a data block in the stripe fails, e.g. due to a failure of the drive containing the drive extent that stores the data block, the lost data block may be recovered by RAID Logic 132 performing an XOR operation across the remaining data blocks and a parity block stored within drive extents located on non-failing data storage drives. Various specific RAID levels having block level data striping with distributed parity may be provided by RAID Logic 132 for individual RAID extents. For example, RAID Logic 132 may provide block level striping with distributed parity error protection according to 4D+1P (“four data plus one parity”) RAID-5 for one or more RAID extents, in which each stripe consists of 4 data blocks and a block of parity information. When 4D+1P RAID-5 is used for a RAID extent, at least five drive extents must be mapped to the RAID extent, so that each one of the four data blocks and the parity information for each stripe can be stored on a different drive extent, and therefore stored on a different storage drive. RAID Logic 132 may alternatively use 4D+2P RAID-6 parity based RAID protection to provide striping with double distributed parity information on a per-stripe basis.

The RAID Metadata Database 162 itself may be stored using mirroring provided within a RAID extent. In some embodiments, RAID Metadata Database 162 may be stored using three way mirroring, e.g. RAID-1. In such embodiments, a separate copy of RAID Metadata Database 162 is maintained on each one of three drive extents that are used to store RAID Metadata Database 162. Indications (e.g. drive numbers, drive extent numbers, etc.) of the drive extents that are used to store copies of the RAID Metadata Database 162 are stored in the configuration metadata. In this way, the stored configuration indicates how RAID Metadata Database 162 is stored in Physical Non-Volatile Data Storage Drives 128.

To provide high reliability for the configuration metadata, multiple copies of the configuration metadata are stored in Physical Non-Volatile Data Storage Drives 128. For example, a separate individual copy of the configuration metadata may be stored on each one of the data storage drives Physical Non-Volatile Data Storage Drives 128. For purposes of illustration in FIG. 1, the copies of the configuration metadata stored in DPE Drives 162 are shown by Copies 166 of the configuration metadata, and the copies of the configuration metadata stored in DAE Drives 164 are shown by Copies 168 of the configuration metadata. The copies of the configuration metadata stored in Physical Non-Volatile Data Storage Drives 128 may include one or more generations of the configuration metadata, e.g. with higher number generations being more recently loaded than lower number generations.

Boot Logic 140 operates to boot the Data Storage System 116, e.g. when the Data Storage System 116 powered up. During the process of booting Data Storage System 116, Configuration Metadata Reliability Checking Logic 142 performs a reliability check with regard to the configuration metadata for Data Storage System 116. For example, Configuration Metadata Reliability Checking Logic 142 may check for and in some cases detect a reliability failure (e.g. Configuration Metadata Reliability Failure 144) with regard to the configuration metadata during the process of booting Data Storage System 116.

In some embodiments, Configuration Metadata Reliability Checking Logic 142 may detect Configuration Metadata Reliability Failure 144 by detecting that the configuration metadata can currently be read from less than a predetermined proportion of the drives in Physical Non-Volatile Data Storage Drives 128. The predetermined proportion of the drives in Physical Non-Volatile Data Storage Drives 128 may, for example, be equal to a majority of the total number of drives in Physical Non-Volatile Data Storage Drives 128.

For example, Configuration Metadata Reliability Checking Logic 142 may detect Configuration Metadata Reliability Failure 144 when insufficient copies of the configuration metadata are currently accessible to Storage Processor 120 from Physical Non-Volatile Data Storage Drives 128. The number of copies of the configuration metadata that are currently accessible to Storage Processor 120 from Physical Non-Volatile Data Storage Drives 128 depends on how many of the drives in Physical Non-Volatile Data Storage Drives 128 are currently functioning and connected to Data Storage System 116. For example, in the event that a communication link connecting Storage Processor 120 to DAE Drives 164 becomes disconnected, all drives in DAE Drives 164 may become inaccessible to Storage Processor 120. In some embodiments, at least one separate copy of the configuration metadata is stored on each individual one of the drives in Physical Non-Volatile Data Storage Drives 128, and Configuration Metadata Reliability Failure 144 is detected when Configuration Metadata Reliability Checking Logic 142 determines that the total number of copies of any individual generation of the configuration metadata accessible by Storage Processor 120 from Physical Non-Volatile Data Storage Drives 128 is half or less than half of the total number of drives in Physical Non-Volatile Data Storage Drives 128. Such a failure event may occur, for example, when at least half of the total number of drives in Physical Non-Volatile Data Storage Drives 128 are contained within DAE Drives 164, and a communication link between DAE Drives 164 and Storage Processor 116 becomes disconnected, resulting in all of the drives in DAE Drives 164 becoming inaccessible to Storage Processor 120. Because the drives in DAE Drives 164 are at least half of the total number of drives in Physical Non-Volatile Data Storage Drives 128, the total number of copies of any individual generation of the configuration metadata accessible by Storage Processor 120 from Physical Non-Volatile Data Storage Drives 128 is then half or less than half of the total number of drives in Physical Non-Volatile Data Storage Drives 128, triggering detection of the reliability failure with regard to the configuration metadata.

In response to detection of the reliability failure regarding the configuration metadata, e.g. in response to detection of Configuration Metadata Reliability Failure 144, Configuration Metadata Generation Validation Logic 146 identifies valid generations of the configuration metadata that are currently stored in Physical Non-Volatile Data Storage Drives 128. For example, Configuration Metadata Generation Validation Logic 146 may read all copies of the configuration metadata that are accessible from Physical Non-Volatile Data Storage Drives 128, and determine which specific generations of the configuration metadata are currently accessible from Physical Non-Volatile Data Storage Drives 128. Configuration Metadata Generation Validation Logic 146 may then perform a loading and validation process with regard to each generation of the configuration metadata for which at least one copy is accessible from Physical Non-Volatile Data Storage Drives 128. In some embodiments, the individual generations of the configuration metadata that are accessible from Physical Non-Volatile Data Storage Drives 128 are validated in an order that is based on the number of copies of each generation that are accessible from Physical Non-Volatile Data Storage Drives 128, such that generations having relatively higher numbers of copies currently accessible from Physical Non-Volatile Data Storage Drives 128 are validated by Configuration Metadata Generation Validation Logic 146 before generations for which relatively fewer copies are currently accessible from Physical Non-Volatile Data Storage Drives 128.

Those generations of the configuration metadata that are both accessible from Physical Non-Volatile Data Storage Drives 128 and determined to be valid by Configuration Metadata Generation Validation Logic 146 are shown in FIG. 1 by Valid Generations of Configuration Metadata 148, and may include one or more generations of configuration metadata 150, 152, 154, etc., that are determined to be valid.

Valid Configuration Metadata Selection Logic 156 then determines a user-selected one of the Valid Generations of Configuration Metadata 148, e.g. User-Selected Valid Generation of Configuration Metadata 158. In some embodiments, Valid Configuration Metadata Generation Selection Logic 156 causes an identifier of each configuration metadata generation in Valid Generations of Configuration Metadata 148 to be displayed in a user interface provided by Data Storage System 116 and/or one of the Hosts 110 to an administrative user, system manager, or the like. Valid Configuration Metadata Generation Selection Logic 156 then receives an indication of one of Valid Generations of Configuration Metadata 148 that was selected by the user, e.g. by clicking on the identifier of one of the Valid Generations of Configuration Metadata 148 within the user interface, and that user-selected one of the Valid Generations of Configuration Metadata 148 is determined to be User-Selected Valid Generation of Configuration Metadata 158. In this way, when Configuration Metadata Reliability Failure 144 is detected by the data storage system, a user is notified of the valid configuration metadata generations that are currently available for booting up the data storage system. The user can then refer to a system journal or the like indicating system administration information such as the completion status of updates performed on the configuration metadata and/or other system components, indications of which generation(s) of configuration metadata are compatible with current versions of other system components, etc., and then select one of Valid Generations of Configuration Metadata 148 based on such information, so that the RAID Logic 132 indicated by location indications in the selected generation of configuration metadata can be used to continue the boot process for the data storage system.

Metadata Database Access and Loading Logic 160 may load RAID Metadata Database 162 from Physical Non-Volatile Data Storage Drives 128 into Memory 126 based on the contents of User-Selected Valid Generation of Configuration Metadata 158, so that RAID Logic 132 can subsequently access and use the contents of RAID Metadata Database 162 when providing RAID protection for User Data 170 and Metadata 172. In this way, RAID Metadata Database 162 is subsequently accessed by Metadata Database Access and Loading Logic 160 and/or RAID Logic 132 based on location indications contained in User-Selected Valid Generation of Configuration Metadata 158.

In some embodiments, Configuration Metadata Generation Validation Logic 146 may identify the Valid Generations of Configuration Metadata 148 at least in part by, for each generation of the configuration metadata for which at least one copy is currently stored in at least one of the currently accessible data storage drives in Physical Non-Volatile Data Storage Drives 128 (e.g. currently stored in one of the drives in DPE Drives 162 after DAE Drives 164 have become disconnected from Storage Processor 120), loading RAID Metadata Database 162 from Physical Non-Volatile Data Storage Drives 128 into Memory 126 based on indications contained in that generation of configuration metadata of the location(s) (e.g. drive number numbers, drive extent numbers, etc.) of RAID Metadata Database 162 within Physical Non-Volatile Data Storage Drives 128. A generation of configuration metadata is determined to be valid in the case where i) the RAID Metadata Database 162 is successfully loaded to Memory 126 from Physical Non-Volatile Data Storage Drives 128 based on location indications of RAID Metadata Database 162 contained in that generation of configuration metadata, and ii) the contents of the loaded RAID Metadata Database 162 are determined to be valid. For example, in some embodiments, if RAID Metadata Database 162 is successfully loaded from Physical Non-Volatile Data Storage Drives 128 based on the location indications contained in a generation of configuration metadata, then the contents of RAID Metadata Database 162 is validated by comparing the result of applying a checksum function to the loaded contents of RAID Metadata Database 162 to one or more checksum values contained within the RAID Metadata Database 162 and/or the generation of metadata. In the case of a match between the result of applying a checksum function to the loaded contents of RAID Metadata Database 162 and a checksum value contained within the RAID Metadata Database 162 and/or the generation of metadata, the contents of RAID Metadata Database 162 are determined to be valid.

In some embodiments Metadata Database Access and Loading Logic 160 may access and load RAID Metadata Database 162 using the contents User-Selected Valid Generation of Configuration Metadata 158 using location indications in User-Selected Valid Generation of Configuration Metadata 158 that indicate multiple drive extents within Physical Non-Volatile Data Storage Drives on which copies of the contents of RAID Metadata Database 162 are stored. For example, in some embodiments, e.g. for purposes of fault tolerance, the contents of RAID Metadata Database 162 may be identically mirrored (e.g. by RAID Logic 132) on three different drive extents located on three different drives using mapped RAID data protection (e.g. mapped RAID-1), such that each one of the three drive extents stores a separate copy of RAID Metadata Database 162. In such embodiments, User-Selected Valid Generation of Configuration Metadata 158 contains a location indication (e.g. drive number and drive extent number) for each one of the three drive extents that are used to store RAID Metadata Database 162, and Metadata Database Access and Loading Logic 160 uses the location indications in User-Selected Valid Generation of Configuration Metadata 158 to access RAID Metadata Database 162 in Physical Non-Volatile Data Storage Drives 128 and load RAID Metadata Database 162 from Physical Non-Volatile Data Storage Drives 128 to Memory 126. It should be recognized that RAID Metadata Database 162 may have previously been accessed and loaded into Memory 132 based on the location indications in User-Selected Valid Generation of Configuration Metadata 158 by Configuration Metadata Generation Validation Logic 146 when generating Valid Generations of Configuration Metadata 148, in which case there may be no need for Metadata Database Access and Loading Logic 160 re-load RAID Metadata Database 162, and the previously loaded RAID Metadata Database 162 can then simply be indicated to RAID Logic 132 as being valid and ready to use to continue the boot process. By allowing the boot process to continue, Data Storage System 116 can then continue to boot up Data Storage System 116 using the RAID Metadata Database 162, and in the event of inaccessibility of some drives, using those drives that are still accessible to provide storage services to Hosts 110, and to also provide an indication that any drives that have been disconnected (and/or logical storage objects based on those disconnected drives) are inaccessible or unavailable, thereby enabling a system administrator user or the like to understand and efficiently address the specific type of failure that has occurred.

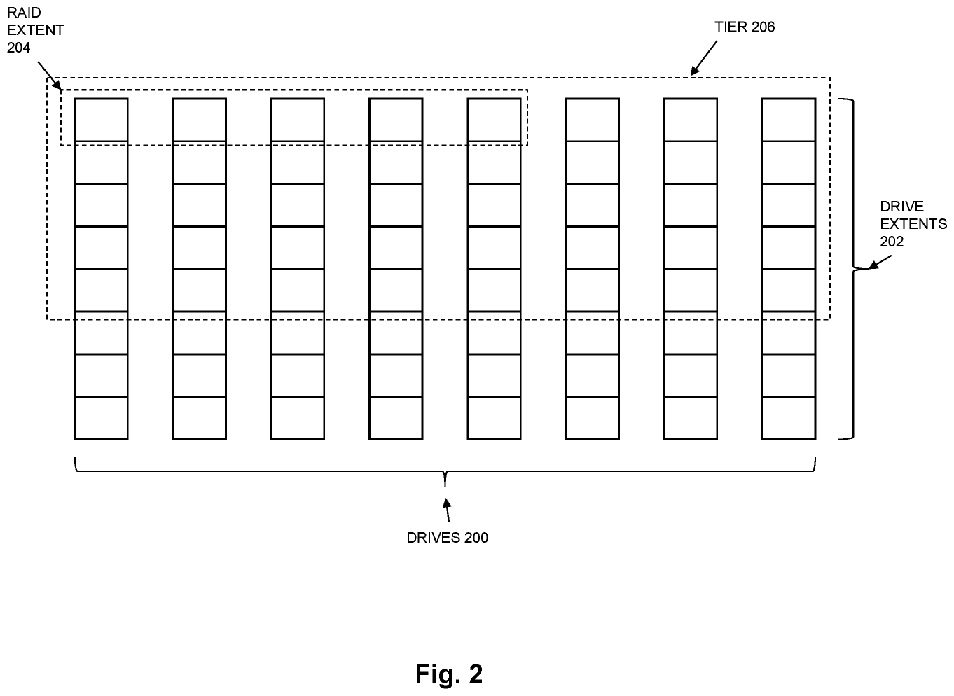

FIG. 2 is a block diagram showing a set of non-volatile data storage drives, i.e. Drives 200, that are divided into Drive Extents 202. FIG. 2 shows an example of a RAID Extent 204, and shows a set of five drive extents within RAID Extent 204 that are assigned and mapped to RAID Extent 204, and are used to store data that is written to RAID Extent 204. In the example of FIG. 2, the five drive extents assigned and mapped to RAID Extent 204 may be used to provide 4D+1P (“four data plus one parity”) RAID-5 for data written to RAID Extent 204. As also shown in FIG. 2, a storage Tier 206 may extend across a relatively larger set of drive extents in Drive Extents 202, and may contain multiple RAID extents.

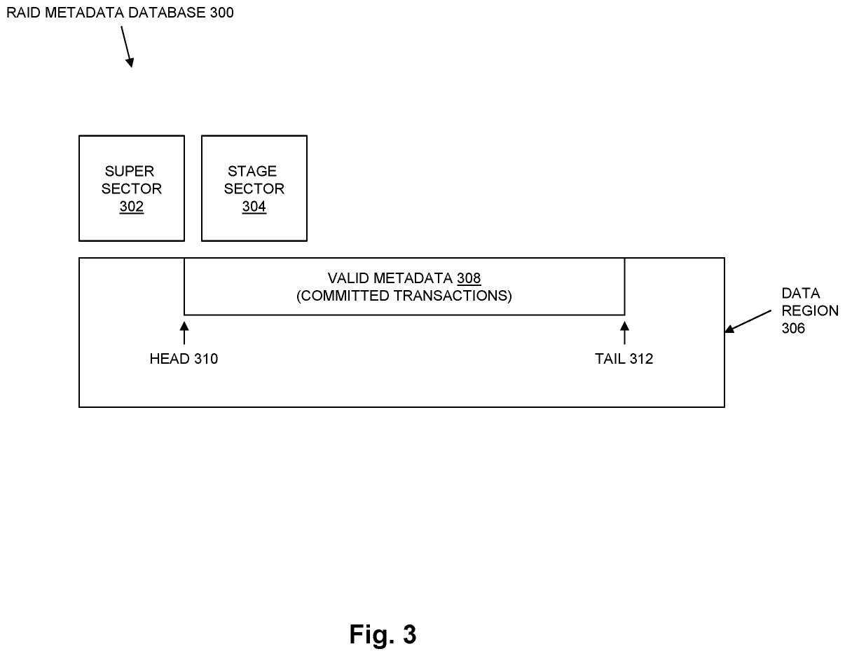

FIG. 3 is a block diagram showing an example of the structure of a metadata database in some embodiments, i.e. RAID Metadata Database 300. As shown in FIG. 3, RAID Metadata Database 300 may include or consist of a Super Sector 302, a Stage Sector 304, and a Data Region 306. The Super Sector 302 may include information indicating the structure and/or current state of the Valid Metadata 308 within Data Region 306, such as a Head 310 and a Tail 312 that define a portion of Data Region 306 that currently contains valid RAID metadata. The Stage Sector 304 may be used to store multiple metadata operations (e.g. read and/or write metadata operations) that are directed to RAID Metadata Database 300. The metadata operations stored in Stage Sector 304 are organized into transactions that are subsequently stored into Valid Metadata 308. For example, Valid Metadata 308 may be structured as a transaction log made up of committed metadata transactions, each of which may include multiple metadata operations. The transactions created from the metadata operations in Stage Sector 304 and then added to Valid Metadata 308 may, for example, be added at the Tail 312 of Valid Metadata 306.

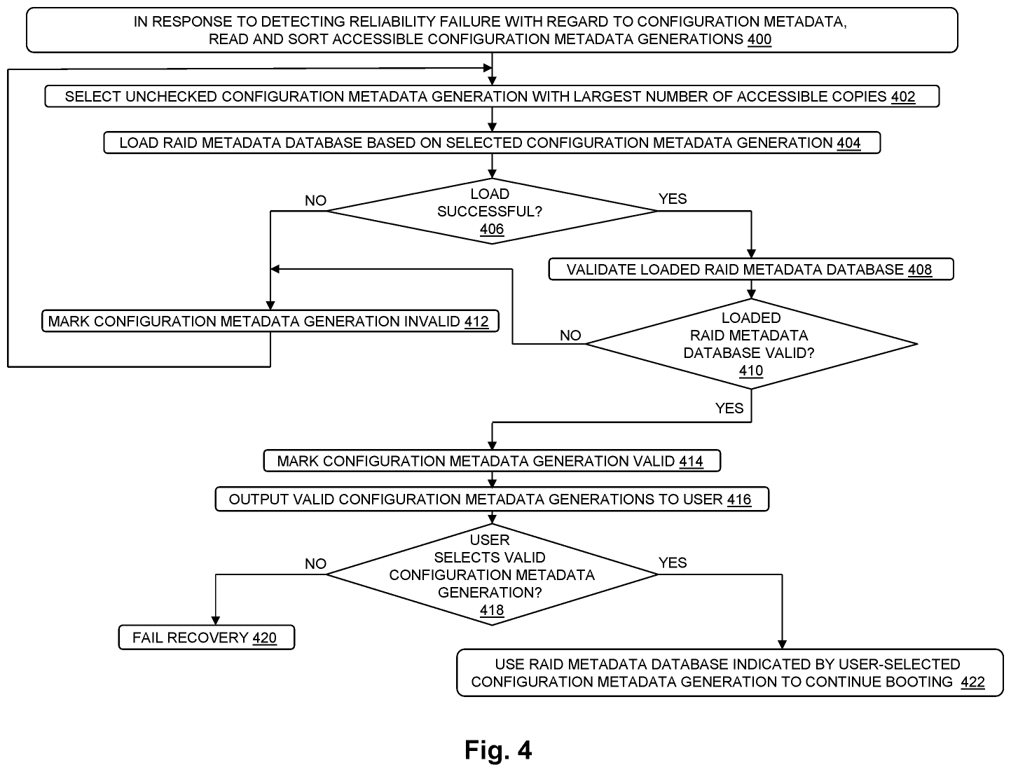

FIG. 4 is a flow chart showing an example of steps performed by some embodiments of the disclosed technology during operation. The steps of FIG. 4 may, for example, be performed by some or all of the components shown in Boot Logic 140 and/or Host I/O Processing Logic 135 of FIG. 1.

At step 400, in response to detecting a reliability failure with regard to configuration metadata of the data storage system, the disclosed technology reads and sorts the generations of configuration metadata that are currently stored in the physical non-volatile data storage of the data storage system. The disclosed technology may, for example, detect a reliability failure with regard to the configuration metadata of the data storage system in the event that the configuration metadata currently can only be read by the storage processor from less than a predetermined proportion of the drives in the physical non-volatile data storage drives of the data storage system, e.g. from less than a majority of all the drives of the data storage system.

In response to detecting the reliability failure with regard to the configuration metadata, the disclosed technology reads all generations of the configuration metadata from the physical non-volatile data storage drives that are currently accessible from the physical non-volatile data storage drives. The disclosed technology may then sort the accessible generations of the configuration metadata based on the numbers of copies of each one of the accessible generations of the configuration metadata that are accessible from the physical non-volatile data storage drives. For example, the disclosed technology may sort the accessible generations of configuration metadata in descending order of total number of copies that are accessible for each generation. Accordingly, based on such a sorting of unchecked generations of configuration metadata performed at step 400, the accessible generations of configuration metadata may subsequently be checked for validity in descending order of accessible copies.

At step 402, the disclosed technology automatically selects the unchecked accessible generation of configuration metadata having the largest number of accessible copies of all the unchecked accessible generations of configuration metadata. Step 402 is followed by step 404.

At step 404, the disclosed technology loads the RAID metadata database from the physical non-volatile data storage drives of the data storage system into the memory of the data storage system based on location indication(s) of the RAID metadata database that are stored in the generation of configuration metadata selected at step 402. Step 404 is followed by step 406.

At step 406, the disclosed technology determines whether the RAID metadata database was successfully loaded from the non-volatile data storage drives of the data storage system to the memory of the data storage system at step 404. If so, step 406 is followed by step 408. Otherwise, step 406 is followed by step 412.

In step 412, the generation of configuration metadata automatically selected at step 402 is marked as checked and invalid. Step 412 is followed by step 402, in which the next unchecked accessible generation of configuration metadata is automatically selected for checking from the sorted list created at step 400.

At step 408, the disclosed technology validates the RAID metadata database that was successfully loaded at step 404. For example, the result of applying a checksum function to the contents of the RAID metadata database loaded at step 404 is compared to a checksum stored within the loaded RAID metadata database. If there is a match, the loaded RAID metadata database is determined to be valid, and step 410 is followed by step 414. Otherwise, step 410 is followed by step 412.

At step 414, the generation of configuration metadata selected at step 402 is marked as checked and valid (e.g. added to Valid Generations of Configuration Metadata 148). Step 414 is followed by step 416, in which some or all of the generations of configuration metadata that have been checked and determined to be valid (e.g. Valid Generations of Configuration Metadata 148) are displayed to a user. For example, at step 416, a generation identifier (e.g. generation number) of each configuration metadata generation within Valid Generations of Configuration Metadata 148 is displayed for potential selection in a graphical user interface provided by the data storage system to a system administrator user or the like.

At step 418, the disclosed technology determines whether the user selected any one of the generations of configuration metadata that were checked and determined to be valid, e.g. by selecting the corresponding generation identifier within the user interface. If so, step 418 is followed by step 422. Otherwise, the system determines that the user has decided not to continue the boot the data storage system using any of the displayed generations of configuration metadata, and step 418 is followed by step 420, at which the process shown in FIG. 4 of recovering from the detected reliability failure with regard to configuration metadata fails.

At step 422, the data storage system accesses and uses the RAID metadata database loaded into the memory of the data storage system based on the generation of configuration metadata that was selected by the user to continue booting the data storage system to an operational state, and to potentially provide data storage services to the hosts using one or more physical data storage drives that remain accessible to the storage processor. The data storage system can then subsequently indicate the cause of the detected reliability failure, e.g. by displaying an indication within the administrative user graphical user interface of one or more specific drives (and/or logical storage objects) that are currently unavailable, e.g. because specific drives cannot be accessed by the storage processor.

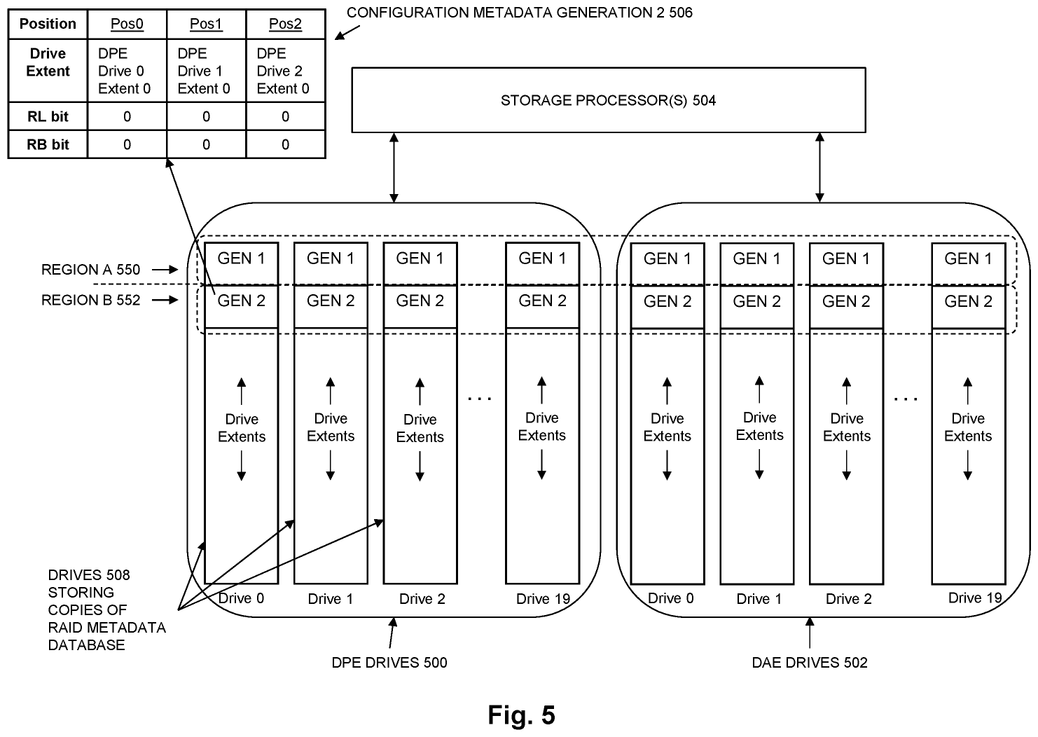

FIG. 5 is a block diagram showing an example of the storage and contents of configuration metadata in some embodiments. In the example of FIG. 5, the physical data storage drives of the data storage system include DPE Drives 500 and DAE Drives 502, and the storage processor or storage processors of the data storage system are shown by Storage Processor(s) 504. DPE Drives 500 contains twenty drives, e.g. Drive 0, Drive 1, Drive 2, and so on through Drive 19. DAE Drives 502 contains another twenty drives, also numbered Drive 0, Drive 1, Drive 2, and so on through Drive 19.

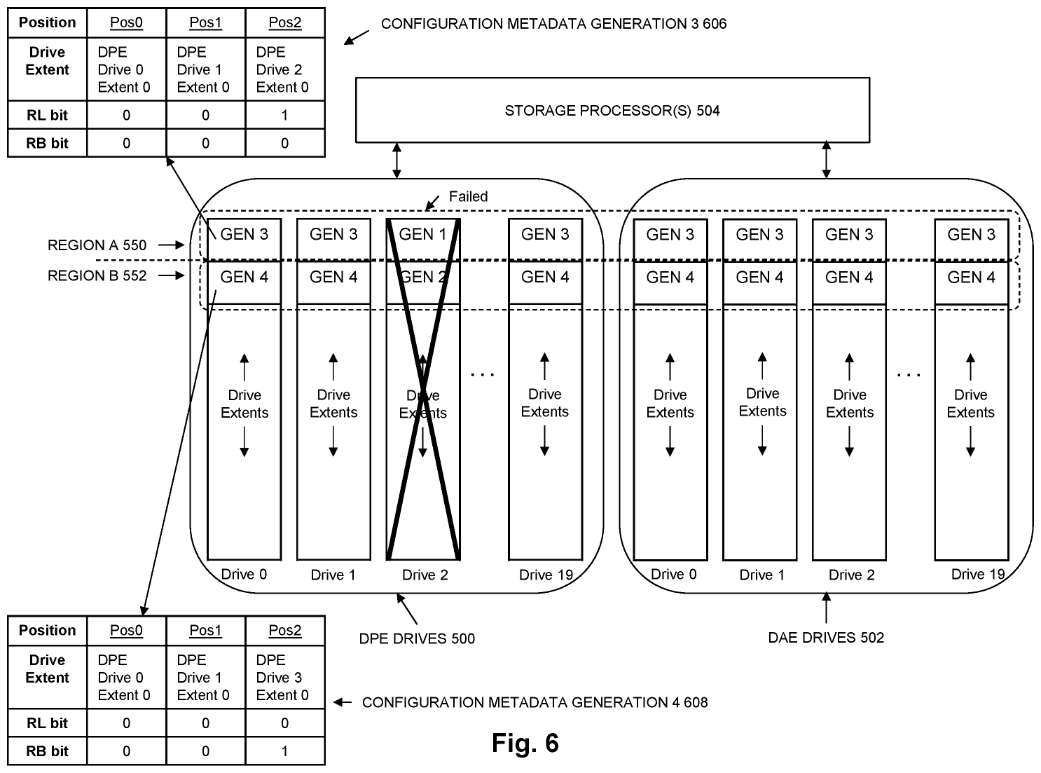

In the example of FIG. 5, a separate copy of the generation metadata of the data storage system is stored in each one of the physical non-volatile data storage drive of the data storage system. Within each physical non-volatile data storage drive, two regions are used to store the generation metadata, i.e. Region A 550 and Region B 552. When a new generation of configuration metadata is generated, it is persistently stored into the one of the two regions that was not used to persistently store the preceding generation of configuration metadata. For example, a separate copy of the first generation of configuration metadata, e.g. Generation 1 (“GEN 1”), was previously stored into Region A 550 within each one of the physical non-volatile data storage drives. When a new generation of configuration metadata was generated and needed to be persistently stored, it was assigned the next generation number, e.g. generation 2 (“GEN 2”), and a separate copy of generation 2 of the configuration metadata was stored into Region B 552 within each one of the physical non-volatile data storage drives. Subsequently, when another generation of configuration metadata is generated and needs to be persistently stored, it will be assigned the next generation number, e.g. generation 3, and a separate copy of generation 3 will be stored into Region A 550 of each physical non-volatile data storage drive, and so on for subsequent configuration metadata generations (see FIGS. 6-8). In addition to and outside of Region A 550 and Region B 552, FIG. 5 shows that each physical non-volatile data storage drive further includes multiple drive extents, which may be numbered from 0 through some highest numbered drive extent within each drive.

As also shown in FIG. 5, the contents of Configuration Metadata Generation 2 506 indicates the locations of three drive extents that store mirrored copies of the RAID metadata database. Specifically, Configuration Metadata Generation 2 506 indicates that the three drive extents storing copies of the RAID metadata database are drive extent 0 in Drive 0 of DPE Drives 500, drive extent 0 in Drive 1 of DPE Drives 500, and drive extent 0 of Drive 2 in DPE Drives 500. In FIG. 5, Drives 508 thus each store a copy of the RAID metadata database.

Configuration Metadata Generation 2 506 also indicates the RAID position of each drive extent used to store a copy of the RAID metadata database, i.e. the position of drive extent 0 of Drive 0 of DPE Drives 500 in the RAID extent for the RAID metadata database is position 0, the position of drive extent 0 of Drive 1 of DPE Drives 500 in the RAID extent for the RAID metadata database is position 1, and the position of drive extent 0 of Drive 2 of DPE Drives 500 in the RAID extent for the RAID metadata database is position 2.

Configuration Metadata Generation 2 506 also indicates a current drive rebuilding status with regard to each one of the drive extents on which copies of the RAID metadata database are stored. Specifically, in the example of FIG. 5, no relevant drive rebuild is underway, and accordingly both the RL (“Evaluate Rebuild Logging”) bit and RB (“Rebuild in Progress”) bit are clear for each of the drive extents on which copies of the RAID metadata database are stored.

FIG. 6 is a block diagram showing the example of FIG. 5 after the failure of one of the drives on which a copy of the RAID metadata database is stored, e.g. Drive 2 in DPE Drives 500. When the failure of Drive 2 in DPE Drives 500 is detected, the RAID metadata database rebuild status information stored in the configuration metadata is modified, resulting in the creation of a new generation of configuration metadata. For example, in response to failure of Drive 2 in DPE Drives 500, the RL bit is set for drive extent 0 of Drive 2 in DPE Drives 500, thus creating a new generation of configuration metadata, i.e. Configuration Metadata Generation 3 606 (“GEN 3”). The set RL bit indicates that drive extent 0 of Drive 2 in DPE Drives 500 has failed, and that another drive extent needs to be or is in the process of being allocated to replace drive extent 0 of Drive 2 in DPE Drives 500 within the set of drive extents that persistently store copies of the RAID metadata database. In response to creation of Configuration Metadata Generation 3 606, copies of Configuration Metadata Generation 3 606 are persistently stored to Region A 550 in each of the drives that are still accessible to Storage Processor(s) 504 (i.e. drives 0,1, and 3-19 in DPE Drives 500, and drives 0-19 in DAE Drives 502).

As also shown in FIG. 6, after a new drive extent is allocated to replace drive extent 0 of Drive 2 in DPE Drives 500 within the set of drive extents that persistently store copies of the RAID metadata database, the rebuild status information stored in the configuration metadata is again modified, resulting in the creation of another new generation of configuration metadata. For example, in response to allocation of drive extent 0 of Drive 3 in DPE Drives 500 to replace drive extent 0 of the failed Drive 2 in DPE Drives 500 within the set of drive extents that persistently store copies of the RAID metadata database, the configuration metadata is modified to indicate that drive extent 0 of Drive 3 in DPE Drives 500 is now the drive extent in RAID extent position 2, by clearing the corresponding RL bit and setting the corresponding RB bit, thus creating a new generation of configuration metadata, i.e. Configuration Metadata Generation 4 608 (“GEN 4”). The set RB bit indicates that drive extent 0 of Drive 3 in DPE Drives 500 has been allocated to replace drive extent 0 of Drive 2 in DPE Drives 500, and that a copy of the RAID metadata database (e.g. in drive extent 0 of drive 0 in DPE Drives 500 or drive extent 0 of drive 1 in DPE Drives 500) is currently is currently being copied to drive extent 0 of Drive 3 in DPE Drives 500. In response to creation of Configuration Metadata Generation 4 608, copies of Configuration Metadata Generation 4 608 are persistently stored to Region B 552 in each of the drives that are still accessible to Storage Processor(s) 504 (i.e. drives 0,1, and 3-19 in DPE Drives 500, and drives 0-19 in DAE Drives 502).

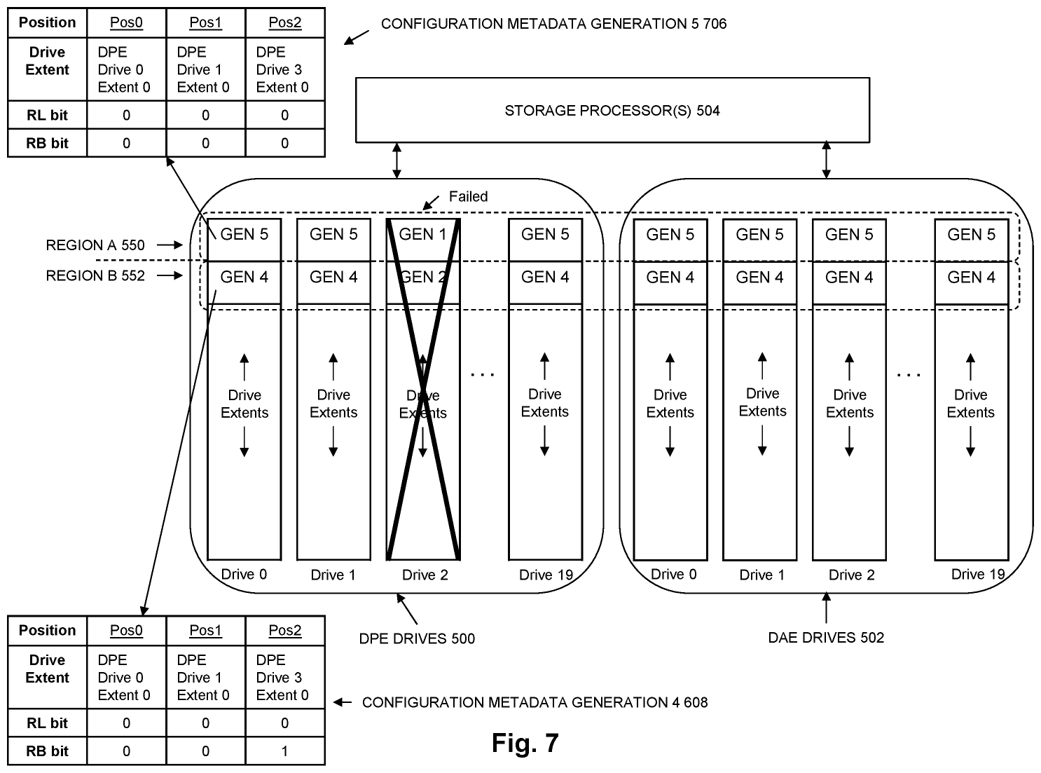

FIG. 7 is a block diagram showing the example of FIG. 6 after the RAID metadata database have been successfully copied to drive extent 0 of Drive 3 in DPE Drives 500. When the RAID metadata database has been completely copied to the replacement drive extent 0 of Drive 3 in DPE Drive 500, the RAID metadata database rebuild status information stored in the configuration metadata is modified, resulting in the creation of a new generation of configuration metadata. For example, in response to the RAID metadata database having been completely copied to the replacement drive extent 0 of Drive 3 in DPE Drive 500, the RB bit is cleared for drive extent 0 of Drive 3 in DPE Drives 500, thus creating a new generation of configuration metadata, i.e. Configuration Metadata Generation 5 706 (“GEN 5”). The cleared RB and RL bit indicate that drive extent 0 of Drive 3 in DPE Drives 500 now is a complete mirror of the other two drive extents that store copies of the RAID metadata database. In response to creation of Configuration Metadata Generation 5 706, copies of Configuration Metadata Generation 5 706 are persistently stored to Region A 550 in each of the drives that are still accessible to Storage Processor(s) 504 (i.e. drives 0,1, and 3-19 in DPE Drives 500, and drives 0-19 in DAE Drives 502).

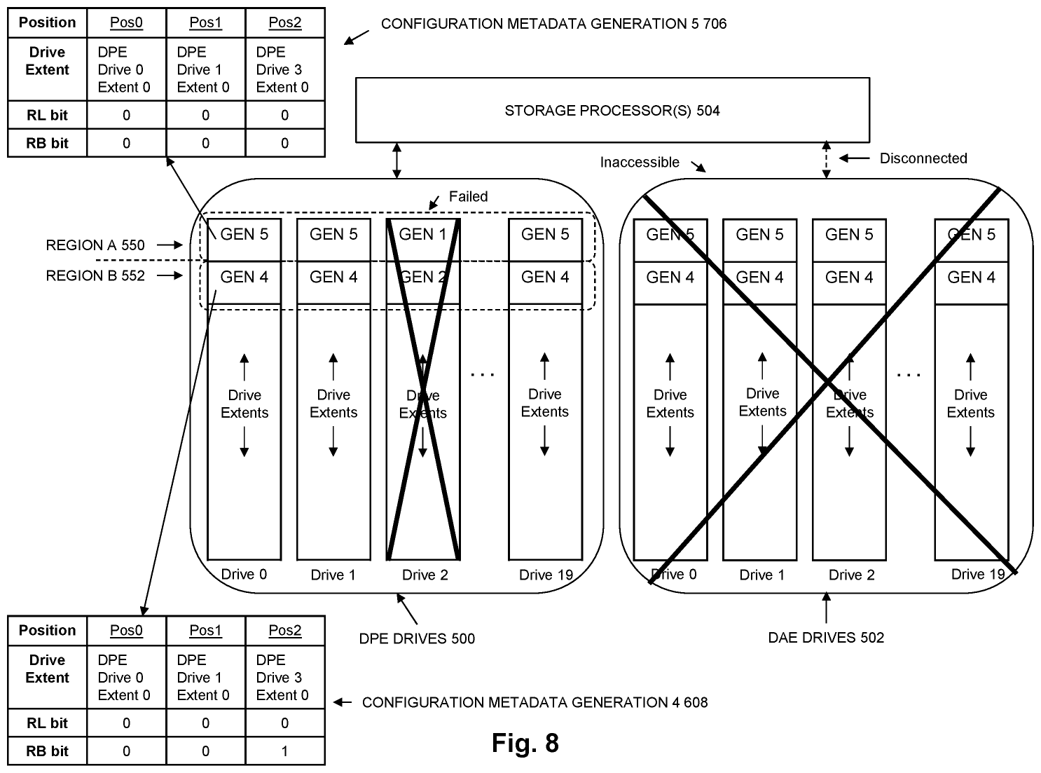

FIG. 8 is a block diagram showing the example of the configuration metadata generations shown in FIG. 7 after detection of a configuration metadata reliability failure. As shown in the example of FIG. 8, all of the DAE Drives 502 have become disconnected from the Storage Processor(s) 504, e.g. as a result of a single communication link connecting the DAE Drives 502 to Storage Processor(s) 504 becoming disconnected. The reliability failure with regard to the configuration metadata is detected because the total number of copies of any individual generation of the configuration metadata accessible by Storage Processor(s) 504 is less than half of the total number of drives in the combined DPE Drives 500 and DAE Drives 502. Specifically, the total number of drives in the combined DPE Drives 500 and DAE Drives 502 is 40, but only 19 copies of either Configuration Metadata Generation 5 706 or Configuration Metadata Generation 4 608 are accessible by Storage Processor(s) 504 (i.e. from drives 0, 1, and 3-19 of DPE Drives 500). In response to detecting the reliability failure with regard to the configuration metadata, the disclosed technology will identify both Configuration Metadata Generation 5 706 and Configuration Metadata Generation 4 608 as valid generations of the configuration metadata, and both Configuration Metadata Generation 5 706 and Configuration Metadata 4 608 will be included in Valid Generations of Configuration Metadata 148. With regard to Configuration Metadata Generation 4 608, the data storage system (e.g. Boot Logic 140 and/or Host I/O Processing Logic 124) will recognize from the set RB bit for drive extent 0 of Drive 3 in DPE Drives 500 that a drive rebuild operation is underway relating to position 3 of the RAID extent for the RAID metadata database, and that the RAID metadata database needs to be copied onto drive extent 0 of Drive 3 in DPE Drives 500 in order for the mirroring of the RAID metadata database to be made current across all three drive extents. With regard to Configuration Metadata Generation 5 706, since none of the RL or RB bits are set, the disclosed technology will recognize that no relevant drive rebuild operation is underway, and that the mirroring of the RAID metadata database across the three drive extents is up to date. Both Configuration Metadata Generation 5 706 and Configuration Metadata 4 608 will accordingly be presented to the administrative user as options for selection by the user, and either one may subsequently be used, if selected by the user, to load the RAID metadata database in order to continue booting the data storage system.

As will be appreciated by one skilled in the art, aspects of the technologies disclosed herein may be embodied as a system, method or computer program product. Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, but not limited to, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto programmable data processing apparatus to produce a machine, such that the instructions which execute on the programmable data processing apparatus create means for implementing the functions specified in the block or blocks. These computer program instructions may also be stored in a computer-readable memory that can direct a programmable data processing apparatus to function in a particular manner, such that the instructions stored in the computer-readable memory produce an article of manufacture including instruction means which implement the function specified in the block or blocks. The computer program instructions may also be loaded onto a programmable data processing apparatus to cause a series of operational steps to be performed on the programmable apparatus to produce a computer implemented process such that the instructions which execute on the programmable apparatus provide steps for implementing the functions specified in the block or blocks.

Those skilled in the art should also readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

What is claimed is:

1. A method comprising:
detecting a reliability failure regarding configuration metadata stored in non-volatile data storage of a data storage system, wherein the configuration metadata indicates how a metadata database is stored in the non-volatile data storage of the data storage system;
in response to detecting the reliability failure regarding the configuration metadata, identifying valid generations of the configuration metadata that are currently stored in the non-volatile data storage of the data storage system;
determining a user-selected one of the valid generations of the configuration metadata; and
accessing the metadata database based on the user-selected one of the valid generations of the configuration metadata.

2. The method of claim 1, wherein identifying the valid generations of the configuration metadata comprises:
for each generation of the configuration metadata currently stored in at least one currently accessible data storage drive in the non-volatile data storage of the data storage system:
loading the metadata database using the generation of the configuration metadata; and determining that the generation of the configuration metadata is valid in response to successfully loading the metadata database using that generation of the configuration metadata and determining that the loaded metadata database is valid.

3. The method of claim 2, further comprising:
wherein accessing the metadata database based on the user-selected one of the valid generations of the metadata database includes locating at least one portion of non-volatile data storage of the data storage system that stores the metadata database using an indication of the at least one portion of non-volatile data storage stored in the contents of the user-selected one of the valid generations of the configuration data.

4. The method of claim 3, wherein the at least one portion of non-volatile data storage of the data storage system that stores the metadata database comprises a plurality of drive extents that are used by the data storage system to provide mapped RAID (Redundant Array of Independent Disks) data protection for the metadata database.

5. The method of claim 4, wherein the RAID data protection provided for the metadata database comprises mirroring of the metadata database onto each one of the plurality of drive extents, and wherein each one of the plurality of drive extents stores a separate copy of the metadata database.

6. The method of claim 5, wherein the metadata database comprises a RAID metadata database describing how user data is stored by the data storage system in the non-volatile data storage of the data storage system to provide mapped RAID data protection for the user data.

7. The method of claim 1, wherein detecting the reliability failure regarding the configuration metadata comprises detecting that the configuration metadata can currently only be read from less than a predetermined proportion of the non-volatile data storage drives in the non-volatile data storage of the data storage system.

8. The method of claim 7, wherein the predetermined proportion of the non-volatile data storage drives in the non-volatile data storage of the data storage system comprises a majority of the non-volatile data storage drives in the non-volatile data storage of the data storage system.

9. The method of claim 8, wherein detecting the reliability failure regarding the configuration metadata comprises detecting the reliability failure regarding the configuration metadata while booting the data storage system.

10. A data storage system comprising:
at least one storage processor including processing circuitry and a memory;
a plurality of non-volatile data storage drives communicably coupled to the storage processor; and
wherein the memory has program code stored thereon, wherein the program code, when executed by the processing circuitry, causes the processing circuitry to:
detect a reliability failure regarding configuration metadata stored in non-volatile data storage of a data storage system, wherein the configuration metadata indicates how a metadata database is stored in the non-volatile data storage of the data storage system;
in response to detection of the reliability failure regarding the configuration metadata, identify valid generations of the configuration metadata that are currently stored in the non-volatile data storage of the data storage system;
determine a user-selected one of the valid generations of the configuration metadata; and
access the metadata database based on the user-selected one of the valid generations of the configuration metadata.

11. The data storage system of claim 10, wherein the program code, when executed by the processing circuitry, further causes the processing circuitry to identify the valid generations of the configuration metadata at least in part by causing the processing circuitry to:
for each generation of the configuration metadata currently stored in at least one currently accessible data storage drive in the non-volatile data storage of the data storage system:
load the metadata database using the generation of the configuration metadata; and
determine that the generation of the configuration metadata is valid in response to successfully loading the metadata database using that generation of the configuration metadata and determining that the loaded metadata database is valid.

12. The data storage system of claim 11, wherein the program code, when executed by the processing circuitry, causes the processing circuitry to access the metadata database based on the user-selected one of the valid generations of the metadata database at least in part by causing the processing circuitry to locate at least one portion of non-volatile data storage of the data storage system that stores the metadata database using an indication of the at least one portion of non-volatile data storage stored in the contents of the user-selected one of the valid generations of the configuration data.

13. The data storage system of claim 12, wherein the at least one portion of non-volatile data storage of the data storage system that stores the metadata database comprises a plurality of drive extents that are used by the data storage system to provide mapped RAID (Redundant Array of Independent Disks) data protection for the metadata database.

14. The data storage system of claim 13, wherein the RAID data protection provided for the metadata database comprises mirroring of the metadata database onto each one of the plurality of drive extents, and wherein each one of the plurality of drive extents stores a separate copy of the metadata database.

15. The data storage system of claim 14, wherein the metadata database comprises a RAID metadata database describing how user data is stored by the data storage system in the non-volatile data storage of the data storage system to provide mapped RAID data protection for the user data.

16. The data storage system of claim 10, wherein the program code, when executed by the processing circuitry, causes the processing circuitry to detect the reliability failure regarding the configuration metadata at least in part by causing the processing circuitry to detect that the configuration metadata can currently only be read from less than a predetermined proportion of the non-volatile data storage drives in the non-volatile data storage of the data storage system.

17. The data storage system of claim 16, wherein the predetermined proportion of the non-volatile data storage drives in the non-volatile data storage of the data storage system comprises a majority of the non-volatile data storage drives in the non-volatile data storage of the data storage system.

18. The data storage system of claim 17, wherein the program code, when executed by the processing circuitry, causes the processing circuitry to detect the reliability failure regarding the configuration metadata at least in part by detecting the reliability failure regarding the configuration metadata while booting the data storage system.

19. A computer program product including a non-transitory computer readable medium having instructions stored thereon, wherein the instructions, when executed on processing circuitry, cause the processing circuitry to perform steps including:
detecting a reliability failure regarding configuration metadata stored in non-volatile data storage of a data storage system, wherein the configuration metadata indicates how a metadata database is stored in the non-volatile data storage of the data storage system;
in response to detecting the reliability failure regarding the configuration metadata, identifying valid generations of the configuration metadata that are currently stored in the non-volatile data storage of the data storage system;
determining a user-selected one of the valid generations of the configuration metadata; and
accessing the metadata database based on the user-selected one of the valid generations of the configuration metadata.
